(19) United States
(12) Patent Application Publication
(10) Pub. No.: US 2023/0100370 A1
(43) Pub. Date: Mar. 30, 2023

(54) RESIN MATERIAL AND METAL SUBSTRATE

(71) Applicant: NAN YA PLASTICS CORPORATION, TAIPEI (TW)

(72) Inventors: TE-CHAO LIAO, TAIPEI (TW); HUNG-YI CHANG, TAIPEI (TW); Chi-Lin Chen, TAIPEI (TW)

(21) Appl. No.: 17/740,318

(22) Filed: May 9, 2022

(30) Foreign Application Priority Data
Sep. 14, 2021 (TW) 110134126

(51) Int. Cl. C08L 71/12; B32B 15/06

(52) U.S. Cl. CPC C08L 71/123; B32B 15/06; C08L 2205/035; C08L 2205/025; B32B 2307/204; B32B 2307/3065

(57) ABSTRACT

A resin material and a metal substrate are provided. The resin material includes a resin composition and inorganic fillers. The inorganic fillers are uniformly dispersed in the resin composition. The resin composition includes 2 wt % to 40 wt % of a liquid rubber, 5 wt % to 60 wt % of a polyphenylene ether resin, 3 wt % to 40 wt % of a crosslinker, and 5 wt % to 40 wt % of a phosphorus flame retardant. A structural formula of the phosphorus flame retardant is shown as Formula (I):

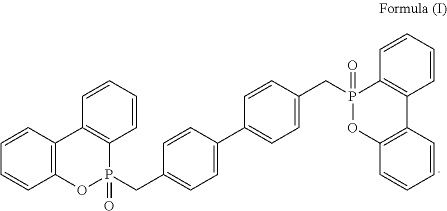 [SMILES: O=P1(Cc2ccc(-c3ccc(CP4(=O)Oc5ccccc5-c5ccccc54)cc3)cc2)Oc2ccccc2-c2ccccc21]

### CROSS-REFERENCE TO RELATED PATENT APPLICATION

This application claims the benefit of priority to Taiwan Patent Application No. 110134126, filed on Sep. 14, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a resin material and a metal substrate, and more particularly to a halogen free resin material and a metal substrate made therefrom.

### BACKGROUND OF THE DISCLOSURE

With the development of the fifth generation wireless system (5G wireless system), high frequency transmission is undoubtedly a main trend to meet requirements for the 5G wireless system. Accordingly, the industry has been devoted to developing a resin material for high frequency (a frequency ranging from 28 GHz to 60 GHz) transmission.

The resin material has a low dielectric constant (Dk) and a low dielectric dissipation factor (Df), so as to have high applicability for high frequency transmission. In this specification, the dielectric constant and the dielectric dissipation factor are collectively referred to as dielectric properties of the resin material.

A resin material on the market usually contains a certain amount of liquid rubber which can enhance compatibility of components in the resin material and enhance a crosslinking degree of the resin material after polymerization. However, the liquid rubber cannot be added without limit When an amount of the liquid rubber is too high, a flame retardancy of the resin material decreases, and an additional flame retardant needs to be added.

Unfortunately, an addition of the flame retardant may negatively influence the dielectric properties. In other words, a resin material that has both the good flame retardancy and the good dielectric properties has yet to be provided in the market.

Therefore, how to adjust the components of the resin material so as to allow the resin material to possess both the flame retardancy and the dielectric properties has become an important issue in the conventional technology.

### SUMMARY OF THE DISCLOSURE

In response to the above-referenced technical inadequacy, the present disclosure provides a resin material and a metal substrate.

In one aspect, the present disclosure provides a resin material. The resin material includes a resin composition and inorganic fillers. The inorganic fillers are uniformly dispersed in the resin composition. The resin composition includes 2 wt % to 40 wt % of a liquid rubber, 5 wt % to 60 wt % of a polyphenylene ether resin, 3 wt % to 40 wt % of a crosslinker, and 5 wt % to 40 wt % of a phosphorus flame retardant. A structural formula of the phosphorus flame retardant is shown as Formula (I):

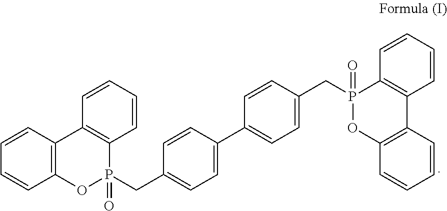 [SMILES: O=P1(Cc2ccc(-c3ccc(CP4(=O)Oc5ccccc5-c5ccccc54)cc3)cc2)Oc2ccccc2-c2ccccc21]

In certain embodiments, a molecular weight of the liquid rubber ranges from 1500 g/mol to 6000 g/mol.

In certain embodiments, the liquid rubber is synthesized from a butadiene monomer. Based on a total amount of the butadiene monomer being 100 mol %, 30 mol % to 98 mol % of the butadiene monomer has a side chain containing an ethylene group after polymerization.

In certain embodiments, the liquid rubber is synthesized from the butadiene monomer and a styrene monomer. Based on the total amount of the liquid rubber being 100 mol %, an amount of the styrene monomer ranges from 10 mol % to 50 mol %.

In certain embodiments, the resin composition includes a bismaleimide resin. Based on a total amount of the resin composition being 100 wt %, an amount of the bismaleimide resin ranges from 5 wt % to 30 wt %.

In certain embodiments, based on a total weight of the resin composition being 100 parts per hundred resin (phr), an amount of the inorganic fillers ranges from 20 phr to 150 phr.

In certain embodiments, the inorganic fillers are processed by a surface modification process to have at least one of an acrylic group and an ethylene group.

In certain embodiments, the inorganic fillers include at least one of silicon dioxide, strontium titanate, calcium titanate, titanium dioxide, and alumina.

In certain embodiments, the resin material includes a siloxane coupling agent. The siloxane coupling agent has at least one of an acrylic group and an ethylene group.

In certain embodiments, based on a total weight of the resin composition being 100 phr, an amount of the siloxane coupling agent ranges from 0.1 phr to 5 phr.

In certain embodiments, a glass transition temperature (Tg) of the resin material ranges from 150° C. to 220° C.

In another aspect, the present disclosure provides a metal substrate. The metal substrate includes a substrate layer and a metal layer disposed on the substrate layer. The substrate layer is formed from a resin material. The resin material includes a resin composition and inorganic fillers. The inorganic fillers are uniformly dispersed in the resin composition. The resin composition includes 2 wt % to 40 wt % of a liquid rubber, 5 wt % to 60 wt % of a polyphenylene ether resin, 3 wt % to 40 wt % of a crosslinker, and 5 wt % to 40 wt % of a phosphorus flame retardant. A structural formula of the phosphorus flame retardant is shown as Formula (I):

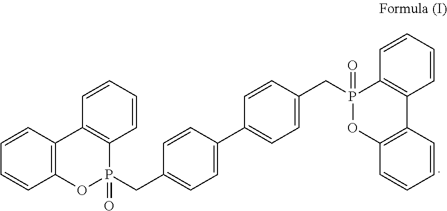 [SMILES: O=P1(Cc2ccc(-c3ccc(CP4(=O)Oc5ccccc5-c5ccccc54)cc3)cc2)Oc2ccccc2-c2ccccc21]

In certain embodiments, a dielectric dissipation of the resin material measured at 10 GHz is lower than 0 0024.

In certain embodiments, a dielectric constant of the resin material measured at 10 GHz is lower than 3 4

In certain embodiments, a peeling strength of the metal substrate ranges from 3.0 lb/in to 6.0 lb/in.

Therefore, in the resin material and the metal substrate provided by the present disclosure, by virtue of “the resin composition including 5 wt % to 40 wt % of the phosphorus flame retardant” and “the phosphorus flame retardant having a structural formula as shown by Formula (I),” the resin material can have good thermal resistance and good dielectric properties.

These and other aspects of the present disclosure will become apparent from the following description of the embodiment taken in conjunction with the following drawings and their captions, although variations and modifications therein may be affected without departing from the spirit and scope of the novel concepts of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

[Resin Material]

A flame retardant used in the present disclosure can address poor flame retardancy of the resin material caused by adding an excessive amount of liquid rubber. An addition of the flame retardant of the present disclosure will not lead to poor dielectric properties (high dielectric constant and high dielectric dissipation). In other words, the addition of the flame retardant of the present disclosure enables the resin material to possess both good flame retardancy and good dielectric properties.

Compared to conventional resin material, the resin material of the present disclosure includes more amount of the flame retardant (preferably being 20 wt %) and has the good dielectric properties (a dielectric constant lower than 3 4 and a dielectric dissipation lower than 0 0024).

Specifically, the resin material of the present disclosure includes a resin composition and inorganic fillers. The inorganic fillers are uniformly dispersed in the resin composition. Specific descriptions and properties for the resin composition and the inorganic fillers are illustrated below.

[Resin Composition]

The resin composition of the present disclosure includes: 2 wt % to 40 wt % of the liquid rubber, 5 wt % to 60 wt % of a polyphenylene ether resin, 3 wt % to 40 wt % of a crosslinker, and 5 wt % to 40 wt % of a phosphorus flame retardant. A structural formula of the phosphorus flame retardant of the present disclosure can be shown as formula (I):

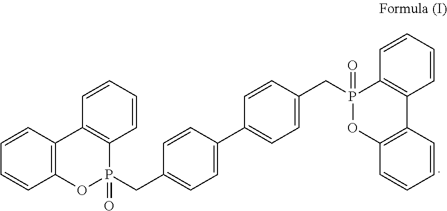 [SMILES: O=P1(Cc2ccc(-c3ccc(CP4(=O)Oc5ccccc5-c5ccccc54)cc3)cc2)Oc2ccccc2-c2ccccc21]

Through the aforesaid components and the contents, the resin composition of the present disclosure can be used to manufacture a metal substrate that has good thermal resistance and good dielectric properties, so as to be applicable for high frequency transmission. In addition, the metal substrate can have a strong adhesive force with a metal layer (i.e. appropriate peeling strength). Specific properties test for the resin material and the metal substrate are illustrated below.

The resin material of the present disclosure contains the liquid rubber. The liquid rubber has a high solubility so that the compatibility of the components in the resin material can be enhanced. In addition, the liquid rubber has reactive functional groups which can enhance a crosslinking degree of the resin material after solidification.

When the liquid rubber of the present disclosure has a molecular weight ranging from 1500 g/mol to 6000 g/mol, flowability of the resin composition can be enhanced. Accordingly, a glue filling property of the resin composition can also be enhanced. Preferably, the molecular weight of the liquid rubber ranges from 1700 g/mol to 5500 g/mol. More preferably, the molecular weight of the liquid rubber ranges from 2000 g/mol to 4000 g/mol.

Based on a total weight of the resin composition being 100 wt %, an amount of the liquid rubber ranges from 1 wt % to 40 wt %. In some embodiments, the amount of the liquid rubber ranges from 2 wt % to 35 wt %. Preferably, the amount of the liquid rubber ranges from 3 wt % to 32 wt %.

In some embodiments, the liquid rubber incudes a liquid diene rubber. Preferably, the liquid diene rubber has a high ratio of a side chain that contains an ethylene group, especially for a liquid diene rubber that has a high ratio of a side chain containing 1, 2-ethylene group.

When the liquid rubber has at least one of an unsaturated side chain that contains an ethylene group (or an ethylene side chain). A crosslink density and the thermal resistance of the resin material after solidification can both be enhanced. Specifically, the liquid rubber is synthesized from a butadiene monomer. The liquid rubber can be synthesized from only the butadiene monomer or synthesized from the butadiene monomer and other monomer. In other words, the liquid rubber can be a butadiene homopolymer or a butadiene copolymer. Preferably, the liquid rubber is the butadiene homopolymer.

When the liquid rubber is synthesized from the butadiene monomer, based on a total weight of the butadiene monomer being 100 mol %, 30 wt % to 98 wt % of the butadiene monomer has the side chain containing the ethylene group after polymerization. In some embodiments, based on a total weight of the butadiene monomer being 100 mol %, 40 wt %, 50 wt %, 60 wt %, 70 wt %, 80 wt %, or 90 wt % of the butadiene monomer has the side chain containing ethylene group after polymerization.

In some embodiments, the liquid rubber is synthesized from the butadiene monomer and a styrene monomer. Based on the total weight of the liquid rubber being 100 mol %, an amount of the styrene monomer ranges from 10 wt % to 50 wt %. When the amount of the styrene monomer ranges from 10 wt % to 50 wt %, a structure of the liquid rubber is likely to be similar to the structure of liquid crystal, such that the thermal resistance and the compatibility of the liquid rubber can both be enhanced.

In some embodiments, based on the total amount of the liquid rubber being 100 mol %, the amount of the styrene monomer can be 15 mol %, 20 mol %, 25 mol %, 30 mol %, 35 mol %, 40 mol %, or 45 mol %.

A molecular weight of the polyphenylene ether resin of the present disclosure ranges from 100 g/mol to 20000 g/mol. Preferably, the molecular weight of the polyphenylene ether resin of the present disclosure ranges from 300 g/mol to 10000 g/mol. More preferably, the molecular weight of the polyphenylene ether resin of the present disclosure ranges from 400 g/mol to 2500 g/mol. When the molecular weight of the polyphenylene ether resin is lower than 20000 g/mol, a solubility of the polyphenylene ether resin in a solvent can be enhanced, such that the resin composition can be prepared easily.

In some embodiments, based on the total weight of the resin composition being 100 wt %, the amount of the polyphenylene ether resin can range from 10 wt % to 50 wt %. Preferably, the amount of the polyphenylene ether resin can range from 20 wt % to 40 wt %. More preferably, the amount of the polyphenylene ether resin can range from 25 wt % to 35 wt %.

In an exemplary embodiment, the polyphenylene ether resin can have at least one modified group. The modified group can be selected from the group consisting of: a hydroxyl group, an amino group, an ethylene group, a styrene group, a methacrylate group, and an epoxy group. Preferably, the modified group is the styrene group or the methacrylate group.

The modified group of the polyphenylene ether resin can provide an unsaturated bond which is beneficial for crosslink reaction, such that the resin material that has a high glass transition temperature and a good thermal resistance can be obtained. In an exemplary embodiment, the polyphenylene ether resin has the modified group at two molecular ends, and the two modified groups are the same. In addition, the resin composition can include one or more kinds of the polyphenylene ether resin.

In an exemplary embodiment, the polyphenylene ether resin includes a first polyphenylene ether and a second polyphenylene ether. The first polyphenylene ether and the second polyphenylene ether are independently the polyphenylene ether resin having hydroxyl modified group at two molecular ends, the polyphenylene ether having styrene modified groups at two molecular ends, the polyphenylene ether having methacrylate modified groups at two molecular ends, or the polyphenylene ether that has epoxy modified groups at two molecular ends. However, the present disclosure is not limited thereto.

A weight ratio of the first polyphenylene ether to the second polyphenylene ether ranges from 0.5 to 1.5. Preferably, the weight ratio of the first polyphenylene ether to the second polyphenylene ether ranges from 0.75 to 1.25. More preferably, the weight ratio of the first polyphenylene ether to the second polyphenylene ether ranges from 0.85 to 1.15.

The resin composition of the present disclosure can further include a bismaleimide resin. Based on the total weight of the resin composition being 100 wt %, an amount of the bismaleimide resin ranges from 5 wt % to 30 wt %. Preferably, the amount of the bismaleimide resin ranges from 6 wt % to 20 wt %. More preferably, the amount of the bismaleimide resin ranges from 7 wt % to 15 wt %.

In some embodiments, the bismaleimide resin has at least two functional groups such that the peeling strength of the metal substrate can be enhanced. However, the present disclosure is not limited thereto.

A molecular weight of the bismaleimide resin of the present disclosure ranges from 500 g/mol to 4500 g/mol. Preferably, the molecular weight of the bismaleimide resin of the present disclosure ranges from 500 g/mol to 3500 g/mol. More preferably, the molecular weight of the bismaleimide resin of the present disclosure ranges from 500 g/mol to 3000 g/mol.

The crosslinker of the present disclosure can enhance a crosslink extent of the polyphenylene ether resin and the liquid rubber. In an exemplary embodiment, the crosslinker can include an allyl group. For example, the crosslinker can be triallyl cyanurate (TAC), triallyl isocyanurate (TRIC), diallyl phthalate, divinylbenzene, triallyl trimellitate, or any combination thereof Preferably, the crosslinker can be triallyl isocyanurate. However, the present disclosure is not limited thereto.

In some embodiments, based on the total weight of the resin composition being 100 wt %, the amount of the crosslinker ranges from 3 wt % to 37 wt %. Preferably, the amount of the crosslinker ranges from 5 wt % to 35 wt %. More preferably, the amount of the crosslinker ranges from 7 wt % to 30 wt %.

The phosphorus flame retardant can be formed from the method below, but is not limited thereto.

In an exemplary embodiment, 432 g (2 moles) of 9,10-dihydro-9-oxa-10-phosphaphenanthrene-10-oxide (DOPO), 251 g (1 mol) of biphenyl dichlorobenzyl and 2400 g of toluene were added to a stirring tank, and then stirred at a temperature of 170° C. for 16 hours, so as to process a reaction and produce a solution. After the solution was cooled to room temperature, hexane was added into the solution to rinse a product of the reaction, and then a white crystalline product is obtained after filtration. Subsequently, the white crystalline product was baked at a temperature of 120° C., so as to obtain the phosphorus-based flame retardant of the present disclosure.

By adding the phosphorus flame retardant as shown in Formula (I), the resin material of the present disclosure can have the good dielectric properties (dielectric constant lower than 3.4 and dielectric dissipation lower than 0.0024). Compared to conventional resin material, the amount of the phosphorus flame retardant of the present disclosure is higher (more than 20 wt %).

In some embodiments, based on the total weight of the resin composition being 100 wt %, the amount of the phosphorus flame retardant ranges from 10 wt % to 38 wt %. Preferably, the amount of the phosphorus flame retardant ranges from 15 wt % to 35 wt %. More preferably, the amount of the phosphorus flame retardant ranges from 25 wt % to 32 wt %.

[Inorganic Fillers]

An addition of the inorganic fillers can help decrease the viscosity and the dielectric constant of the resin material. Some kinds of the inorganic fillers can also enhance the thermal conductivity of the resin material. The aforementioned descriptions above are for illustrative purposes only, and the present disclosure is not limited thereto.

In the present disclosure, the inorganic fillers include silicon dioxide, strontium titanate, calcium titanate, titanium dioxide, alumina, or any combination thereof However, the present disclosure is not limited thereto. In a preferable embodiment, the inorganic fillers include silicon dioxide, alumina, and titanium dioxide at the same time. In addition, the silicon dioxide can be fused silica or crystalline silica. Preferably, the silicon dioxide is fused silica.

In a preferable embodiment, the inorganic fillers are processed by a surface modification process to have at least one of an acrylic group and an ethylene group. Therefore, the inorganic fillers can react with the liquid rubber so that the resin composition can have a good compatibility with the inorganic fillers, and the thermal resistance of the metal substrate is not negatively influenced. Therefore, the resin material of the present disclosure is suitable to be used as a high frequency substrate material.

It should be noted that the inorganic fillers can include only one kind component or include various kinds of components. In addition, the inorganic fillers can be entirely processed by the surface modification, or only a part of the inorganic fillers is processed by the surface modification, so as to have at least one of the acrylic group and the ethylene group. For example, in one embodiment, when the inorganic fillers include silicon dioxide and alumina, silicon dioxide is processed by the surface modification to have at least one of the acrylic group and the ethylene group, while alumina is not processed by the surface modification. However, the present disclosure is not limited thereto.

An appearance of the inorganic fillers can be granular. An average particle size (D50) of the inorganic fillers ranges from 0.3 μm to 3 μm. The particle size (D99) of the inorganic fillers is lower than 10 μm, such that the inorganic fillers can be uniformly dispersed in the resin composition.

An amount of the inorganic fillers can be adjusted according to requirements of products. In an exemplary embodiment, based on the total weight of the resin composition being 100 phr, the amount of the inorganic fillers ranges from 20 phr to 150 phr. Preferably, the amount of the inorganic fillers ranges from 30 phr to 120 phr. More preferably, the amount of the inorganic fillers ranges from 40 phr to 100 phr. However, the present disclosure is not limited thereto.

[Siloxane Coupling Agent]

The resin material can further include a siloxane coupling agent. Due to an addition of the siloxane coupling agent, a reactivity and a compatibility between a fiber cloth, the resin composition, and the inorganic fillers can be enhanced, thereby increasing the peeling strength and thermal resistance of the metal substrate.

In a preferable embodiment, the siloxane coupling agent has at least one of an acrylic group and an ethylene group. A molecular weight of the siloxane coupling agent ranges from 100 g/mol to 500 g/mol. Preferably, the molecular weight of the siloxane coupling agent ranges from 110 g/mol to 250 g/mol. More preferably, the molecular weight of the siloxane coupling agent ranges from 120 g/mol to 200 g/mol.

Based on the total weight of the resin composition being 100 phr, the amount of the siloxane coupling agent ranges from 0.1 phr to 5 phr. Preferably, the amount of the siloxane coupling agent ranges from 0.5 phr to 3 phr.

[Catalyst]

The resin material can further include a catalyst. The catalyst facilitates the solidification of the resin material to form the high frequency substrate. Based on the total weight of the resin composition being 100 phr, the amount of the catalyst ranges from 0.1 phr to 1 phr.

For example, the catalyst can be imidazole compounds, such as triphenylimidazole, 2-ethyl-4-methylimidazole (2E4MZ), 1-Benzyl-2-phenylimidazole (1B2PZ), 1-cyanoethyl-2-phenylimidazole (2PZ-CN), or 2,3-dihydro-1H-pyrrole[1,2-a]benzimidazole (TBZ). However, the present disclosure is not limited thereto.

[Property Test]

In order to prove that the resin material can be used as the high frequency substrate material, 2 wt % to 40 wt % of the liquid rubber, 5 wt % to 60 wt % of the polyphenylene ether resin, 5 wt % to 30 wt % of the bismaleimide resin, 3 wt % to 40 wt % of the crosslinker, and 5 wt % to 40 wt % of the phosphorus flame retardant are mixed to form the resin composition. In addition, the inorganic fillers are further added into the resin composition to form the resin material of Examples 1 to 5 and Comparative Examples 1 to 10. Specific contents of the resin material of Examples 1 to 5 and Comparative Examples 1 to 10 are listed in Table 1. The glass transition temperature, the dielectric constant, and the dielectric dissipation of the resin material in each of Examples 1 to 5 and Comparative Examples 1 to 10 is listed in Table 2.

Subsequently, a fiber cloth is immersed into the resin material in each of Examples 1 to 5 and Comparative Examples 1 to 10. After being immersed, dried, and modeled, a prepreg is obtained. After the prepreg is processed, a metal layer is disposed on the prepreg so as to form the metal substrate in each of Examples 1 to 5 and Comparative Examples 1 to 10. The peeling strength and the thermal resistance of the metal substrate in each of Examples 1 to 5 and Comparative Examples 1 to 10 are listed in Table 2.

In Table 1, a molecular weight of the polybutadiene A is 1200 g/mol, and the polybutadiene A contains 85 mol % of 1, 2-ethylene group side chain. A molecular weight of the polybutadiene B is 2100 g/mol, and the polybutadiene B contains more than 90 mol % of 1, 2-ethylene group side chain. A molecular weight of the butadiene/styrene/divinylbenzene copolymer is 5300 g/mol. A molecular weight of the butadiene/styrene copolymer is 8600 g/mol. The butadiene/styrene copolymer contains 17 mol % to 27 mol % of styrene monomer and 40 mol % of 1, 2-ethylene group side chain. A molecular weight of the polybutadiene C is 3000 g/mol, and the polybutadiene C contains 70 mol % to 80 mol % of 1, 2-ethylene group side chain.

In Table 2, the properties of the resin material/the metal substrate are measured by methods below.
(1) Glass transition temperature: measuring the glass transition temperature of the resin material by a dynamic mechanical analyzer (DMA);
(2) Dielectric constant (10 GHz): detecting the dielectric constant of the resin material at 10 GHz by a dielectric analyzer (model: HP Agilent E4991A);
(3) Dielectric dissipation factor (10 GHz): detecting the dielectric dissipation factor of the resin material at 10 GHz by a dielectric analyzer (model: HP Agilent transition temperature);
(4) Peeling strength: measuring the peeling strength of the metal substrate according to the standard method of IPC-TM-650-2.4.8;
(5) Thermal resistance: heating the metal substrate in an autoclave with a temperature of 120° C. and a pressure of 2 atm, and then putting into a soldering furnace of 288° C. to calculate a duration for a delamination process. If the duration for the delamination process is longer than 10 minutes, a term “OK” is shown in Table 1. If the duration for the delamination is shorter than 10 minutes, a term “NG” is shown in Table 1.

TABLE 1

| | | Example | | | | | Comparative Example | | |
|---|---|---|---|---|---|---|---|---|---|
| (phr) | | 1 | 2 | 3 | 4 | 5 | 1 | 2 | 3 |
| Liquid | Polybutadiene A | — | — | — | — | — | — | — | — |
| rubber | Polybutadiene B | 2.1 | 8.6 | 8.6 | 8.6 | — | 8.6 | 8.6 | 8.6 |
| | butadiene/styrene/ | — | — | — | — | — | — | — | — |
| | divinylbenzene copolymer | | | | | | | | |
| | butadiene/styrene copolymer | — | — | — | — | 8.6 | — | — | — |
| | Polybutadiene C | — | 2.1 | 4.3 | 8.6 | — | 2.1 | 2.1 | 2.1 |
| Polyphenyl ether resin having methacrylate | | 17 | 19 | 17 | 17 | 17 | 19 | 19 | 19 |
| groups at two molecular ends | | | | | | | | | |
| Polyphenyl ether resin having styrene groups | | — | — | — | — | — | — | — | — |
| at two molecular ends | | | | | | | | | |
| Bismaleimide resin | | 4.2 | 4.2 | 4.2 | 4.2 | — | 4.2 | 4.2 | 4.2 |
| Crosslinker | | 19.4 | 8.6 | 8.6 | 4.3 | 8.6 | 8.6 | 8.6 | 8.6 |
| Flame | Phosphorus flame retardant | 17 | 17 | 17 | 17 | 17 | — | — | — |
| retardant | of the present disclosure | | | | | | | | |
| | Model: OP935 | — | — | — | — | — | 17 | — | — |
| | Model: PX200 | — | — | — | — | — | — | 17 | — |
| | Model: SPB100 | — | — | — | — | — | — | — | 17 |
| | Model: SPV100 | — | — | — | — | — | — | — | — |
| Inorganic filler (silicon dioxide) | | 40 | 40 | 40 | 40 | 40 | 40 | 40 | 40 |
| Siloxane | Silane having acrylic group | 1 | 1 | 1 | — | 1 | — | — | 1 |
| coupling | Silane having ethylene group | — | — | — | — | — | — | — | — |
| agent | Silane having epoxy group | — | — | — | — | — | — | — | — |

| | | Comparative Example | | | | | | |
|---|---|---|---|---|---|---|---|---|
| (phr) | | 4 | 5 | 6 | 7 | 8 | 9 | 10 |
| Liquid | Polybutadiene A | — | — | — | 8.6 | 4.3 | — | — |
| rubber | Polybutadiene B | 8.6 | — | — | — | — | 4.3 | — |
| | butadiene/styrene/ | — | 8.6 | — | — | 4.3 | — | — |
| | divinylbenzene copolymer | | | | | | | |
| | butadiene/styrene copolymer | — | — | 8.6 | — | — | 4.3 | 4.3 |
| | Polybutadiene C | 2.1 | 4.3 | 4.3 | 4.3 | — | — | 4.3 |
| Polyphenyl ether resin having methacrylate | | 19 | 17 | 17 | — | — | — | — |
| groups at two molecular ends | | | | | | | | |
| Polyphenyl ether resin having styrene groups | | — | — | — | 17 | 17 | 17 | 17 |
| at two molecular ends | | | | | | | | |
| Bismaleimide resin | | 4.2 | 4.2 | 4.2 | 4.2 | 4.2 | 4.2 | 4.2 |
| Crosslinker | | 8.6 | 8.6 | 8.6 | 8.6 | 12.8 | 12.8 | 12.8 |
| Flame | Phosphorus flame retardant | — | — | — | — | — | — | — |
| retardant | of the present disclosure | | | | | | | |
| | Model: OP935 | — | — | — | — | — | — | — |
| | Model: PX200 | — | — | — | 17 | — | — | — |
| | Model: SPB100 | — | — | 17 | — | — | 17 | 17 |
| | Model: SPV100 | 17 | 17 | — | — | 17 | — | — |
| Inorganic filler (silicon dioxide) | | 40 | 40 | 40 | 40 | 40 | 40 | 40 |
| Siloxane | Silane having acrylic group | 1 | — | — | — | — | — | — |
| coupling | Silane having ethylene group | — | — | — | — | — | — | — |
| agent | Silane having epoxy group | — | — | — | — | — | — | — |

TABLE 2

| | Example | | | | | Comparative Example | |
|---|---|---|---|---|---|---|---|
| | 1 | 2 | 3 | 4 | 5 | 1 | 2 |
| Glass transition | 205 | 210 | 180 | 160 | 213 | 209 | 195 |
| temperature (° C.) | | | | | | | |
| Dielectric constant | 3.05 | 3.03 | 3.04 | 3.02 | 3.03 | 3.14 | 3.21 |
| (10 GHz) | | | | | | | |
| Dielectric dissipation | 2.3 | 1.5 | 1.4 | 1.3 | 1.6 | 2.7 | 2.6 |
| (10 GHz) × 103 | | | | | | | |
| Peeling strength (lb/in) | 4.2 | 4.7 | 4.5 | 3.4 | 3.7 | 4 | 3.9 |
| Thermal resistance | OK | OK | OK | OK | OK | OK | OK |

| | Comparative Example | | | | | | | |
|---|---|---|---|---|---|---|---|---|
| | 3 | 4 | 5 | 6 | 7 | 8 | 9 | 10 |
| Glass transition | 197 | 207 | 200 | 203 | 204 | 198 | 175 | 189 |
| temperature (° C.) | | | | | | | | |
| Dielectric constant | 3.13 | 3.17 | 3.2 | 3.4 | 3.6 | 3.1 | 3.2 | 3.4 |
| (10 GHz) | | | | | | | | |
| Dielectric dissipation | 2.7 | 2.3 | 2.7 | 2.6 | 2.1 | 3.2 | 3.1 | 2.4 |
| (10 GHz) × 103 | | | | | | | | |
| Peeling strength (lb/in) | 4.1 | 4.2 | 3.7 | 3.6 | 3.3 | 3.7 | 3.1 | 3.9 |
| Thermal resistance | NG | NG | OK | OK | OK | NG | NG | OK |

According to the results in Table 1 and Table 2, the phosphorus flame retardant of the present disclosure can enable the resin material to have both the good flame retardancy and the good dielectric properties. Specifically, the dielectric constant (10 GHz) of the resin material of the present disclosure is lower than 3 4, and the dielectric dissipation (10 GHz) of the resin material of the present disclosure is lower than 0 0024, which are better than the dielectric properties of the resin material in Comparative Examples 1 to 10 (using conventional flame retardants).

According to the results from Examples 1 to 5, the glass transition temperature of the resin material ranges from 150° C. to 220° C., and the peeling strength of the metal substrate of the present disclosure ranges from 3.2 lb/in to 5.5 lb/in.

According to the results from Examples 1 to 5, the dielectric properties of the resin material are related to different amounts of the liquid rubber. When the amount of the liquid rubber ranges from 3 wt % to 30 wt %, the resin material can have good dielectric properties. Specifically, when the amount of the liquid rubber ranges from 15 wt % to 25 wt %, the dielectric constant of the resin material can be lower than 3.1 and the dielectric dissipation of the resin material can be lower than 0 0024.

According to the result of Example 5, when the liquid rubber is synthesized from the butadiene monomer and the styrene monomer, and the liquid rubber contains 10 wt % to 50 wt % of the styrene monomer, the resin material can have a higher glass transition temperature.

### Beneficial Effects of the Embodiments

In conclusion, in the resin material and the metal substrate provided by the present disclosure, by virtue of “the resin composition including 5 wt % to 40 wt % of the phosphorus flame retardant” and “the phosphorus flame retardant having a structural formula as shown by Formula (I)”, the resin material can have good thermal resistance and good dielectric properties.

Further, by virtue of “the molecular weight of the liquid rubber ranging from 1500 g/mol to 6000 g/mol”, the resin composition can have good flowability such that the glue filling property of the resin composition can also be enhanced.

Further, by virtue of “based on the total weight of the butadiene monomer being 100 mol %, 30 mol % to 98 mol % of the butadiene monomer having the side chain containing the ethylene group after polymerization”, the metal substrate can have good peeling strength and good thermal resistance.

Further, by virtue of “the liquid rubber being synthesized from the butadiene monomer and the styrene monomer, and the liquid rubber containing 10 wt % to 50 wt % of the styrene monomer”, the metal substrate can have good thermal resistance.

Further, by virtue of “the siloxane coupling agent having at least one of the acrylic group and the ethylene group”, the metal substrate can have good peeling strength and good thermal resistance.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A resin material, comprising a resin composition and inorganic fillers, the inorganic fillers being uniformly dispersed in the resin composition, wherein the resin composition includes:
2 wt % to 40 wt % of a liquid rubber;
5 wt % to 60 wt % of a polyphenylene ether resin;
3 wt % to 40 wt % of a crosslinker; and
5 wt % to 40 wt % of a phosphorus flame retardant having a structural formula shown as Formula (I) below:

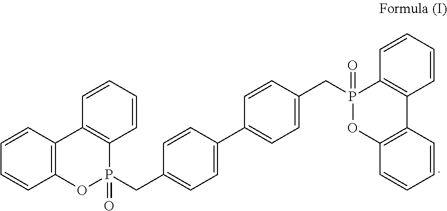 [SMILES: O=P1(Cc2ccc(-c3ccc(CP4(=O)Oc5ccccc5-c5ccccc54)cc3)cc2)Oc2ccccc2-c2ccccc21]

2. The resin material according to claim 1, wherein a molecular weight of the liquid rubber ranges from 1500 g/mol to 6000 g/mol.

3. The resin material according to claim 1, wherein the liquid rubber is synthesized from a butadiene monomer, and based on a total amount of the butadiene monomer being 100 mol %, 30 mol % to 98 mol % of the butadiene monomer has a side chain containing an ethylene group after polymerization.

4. The resin material according to claim 3, wherein the liquid rubber is synthesized from the butadiene monomer and a styrene monomer, and based on the total amount of the liquid rubber being 100 mol %, an amount of the styrene monomer ranges from 10 mol % to 50 mol %.

5. The resin material according to claim 1, wherein the resin composition includes a bismaleimide resin, based on a total amount of the resin composition being 100 wt %, an amount of the bismaleimide resin ranges from 5 wt % to 30 wt %.

6. The resin material according to claim 1, wherein, based on a total weight of the resin composition being 100 phr, an amount of the inorganic fillers ranges from 20 phr to 150 phr.

7. The resin material according to claim 1, wherein the inorganic fillers are processed by a surface modification process to have at least one of an acrylic group and an ethylene group.

8. The resin material according to claim 1, wherein the inorganic fillers include at least one of silicon dioxide, strontium titanate, calcium titanate, titanium dioxide, and alumina.

9. The resin material according to claim 1, further including a siloxane coupling agent, wherein the siloxane coupling agent has at least one of an acrylic group and an ethylene group.

10. The resin material according to claim 9, wherein, based on a total weight of the resin composition being 100 phr, an amount of the siloxane coupling agent ranges from 0.1 phr to 5 phr.

11. The resin material according to claim 1, wherein a glass transition temperature of the resin material ranges from 150° C. to 220° C.

12. A metal substrate, comprising a substrate layer and a metal layer disposed on the substrate layer, the substrate layer being formed from a resin material, and the resin material including a resin composition and inorganic fillers uniformly dispersed in the resin composition, wherein the resin composition includes:
2 wt % to 40 wt % of a liquid rubber;
5 wt % to 60 wt % of a polyphenylene ether resin;
3 wt % to 40 wt % of a crosslinker; and
5 wt % to 40 wt % of a phosphorus flame retardant having a structural formula shown as Formula (I) below:

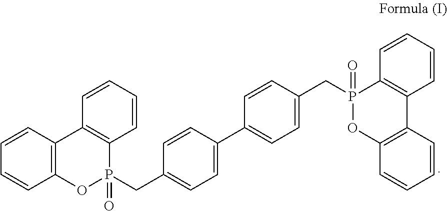 [SMILES: O=P1(Cc2ccc(-c3ccc(CP4(=O)Oc5ccccc5-c5ccccc54)cc3)cc2)Oc2ccccc2-c2ccccc21]

13. The metal substrate according to claim 12, wherein the dielectric dissipation of the resin material measured at 10 GHz is lower than 0 0024.

14. The metal substrate according to claim 12, wherein the dielectric constant of the resin material measured at 10 GHz is lower than 3 4

15. The metal substrate according to claim 12, wherein the peeling strength of the metal substrate ranges from 3.0 lb/in to 6.0 lb/in.
